(19) United States
(12) Patent Application Publication
(10) Pub. No.: US 2008/0217240 A1
(43) Pub. Date: Sep. 11, 2008

(54) ORIENTED ZEOLITE FILM-PROVIDED STRUCTURE

(75) Inventors: Miyuki Yabuki, Nagoya-City (JP); Kenji Suzuki, Nagoya-City (JP); Shinji Nakamura, Kasugai-City (JP); Toshihiro Tomita, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 12/118,929

(22) Filed: May 12, 2008

Related U.S. Application Data
(63) Continuation of application No. PCT/JP2006/323523, filed on Nov. 17, 2006.

(30) Foreign Application Priority Data
Nov. 17, 2005 (JP) 2005-332535

(51) Int. Cl. B01D 39/00; B32B 5/18

(52) U.S. Cl. 210/500.25; 428/220

(57) ABSTRACT

An oriented zeolite membrane-provided structure comprising a support and a membrane-like, MFI type zeolite crystal (an oriented zeolite membrane) provided on the surface of the support, wherein, in the zeolite crystal, the proportion of zeolite crystals whose c-axes are oriented at an angle of 90°±33.76° relative to the surface of the support, is 90% or more of the whole zeolite crystals and the oriented zeolite membrane has a thickness of 1 to 30 μm. The present invention provides an oriented zeolite membrane-provided structure comprising a support and an oriented zeolite membrane provided thereon, wherein the c-axes of zeolite crystals of the membrane are oriented in a direction vertical to the surface of the support and the thickness of the membrane is small.

### TECHNICAL FIELD

The present invention relates to an oriented zeolite membrane-provided structure. More particularly, the present invention relates to an oriented zeolite membrane-provided structure wherein a zeolite oriented membrane whose thickness is thin is provided on the surface of a support therefor, and the C-axes of zeolite crystals of the membrane are oriented in the vertical direction to the surface of the support.

### BACKGROUND ART

Zeolite is a kind of silicate having a reticulate crystal structure in which fine pores of uniform diameter are formed. It is known that zeolite has various chemical compositions represented by a general formula of WmZnO₂n.sH₂O (W: sodium, potassium, calcium or the like; Z: silicon, aluminum or the like; s: various values) and has crystal structures of many kinds (types) different in pore shape. These zeolites have inherent absorbabilities, catalytic activities, solid acid characteristics, ion exchange abilities, etc., based on respective chemical compositions and crystal structures and are used in various applications such as adsorbent, catalyst, catalyst carrier, gas separation membrane, and ion exchanger.

Among them, an MFI type zeolite is a zeolite having pores of about 0.5 nm formed by the oxygen-containing ten-membered ring in the crystal and is used generally in applications such as adsorbent for adsorbing harmful substances such as nitrogen oxides (NOₓ) and hydrocarbons (HC) present in automobile exhaust gas, catalyst for decomposing such harmful substances, and the like.

Zeolite is ordinarily powdery or particulate. However, it has become possible to mold zeolite into a membrane to use the zeolite membrane as a separation membrane. A zeolite membrane is obtained, for example, by a hydrothermal synthesis, where zeolite raw materials are subjected to heating in the presence of steam to make zeolite crystals precipitated on the surface of a support in a membrane shape.

In such a zeolite crystal membrane, the orientation of crystal axes relative to the surface of zeolite crystal membrane varies depending upon the state in which the zeolite crystals are formed, and there are, for example, random orientation or orientation in which the b-axis or c-axis of each crystal is oriented in a direction vertical to the surface of zeolite crystal membrane (see, for example, patent documents 1 to 4).

Patent document 1: JP-A-2000-26115

Patent document 2: JP-A-2004-250290

Patent document 3: JP-A-10-502609

Patent document 4: JP-A-2000-507909

### DISCLOSURE OF THE INVENTION

In the patent documents 1 and 2, a zeolite membrane is disclosed in which the b-axes of zeolite crystals are oriented in a direction vertical to the surface of the support. In the patent documents 3 and 4, a zeolite membrane is disclosed in which the c-axes of zeolite crystals are oriented in a direction vertical to the surface of the support. These zeolite membranes can be used as a separation membrane for separating various kinds of substances, depending upon the structure of each membrane. In these patent documents, however, there is no mention of using a zeolite membrane as a separation membrane for concentration and separation of ethanol from a mixed solution of water and ethanol, i.e. a water/ethanol separation membrane.

The present invention has been made in view of the above problem and is characterized in that a zeolite oriented membrane whose thickness is thin is provided on the surface of a support therefor, and the c-axes of zeolite crystals of the membrane are oriented in the vertical direction to the surface of the support, and that it is suitably usable for a water/ethanol separation membrane.

In order to achieve the above aim, the present invention provides an oriented zeolite membrane-provided structure which is described below.

[1] An oriented zeolite membrane-provided structure comprising a support and a membrane-like, MFI type zeolite crystal (an oriented zeolite membrane) provided on the surface of the support, wherein, in the zeolite crystal, the proportion of zeolite crystals whose c-axes are oriented at an angle of 90°±33.76° relative to the surface of the support, is 90% or more of the whole zeolite crystals and the oriented zeolite membrane has a thickness of 1 to 30 μm.
[2] An oriented zeolite membrane-provided structure according to [1], wherein, with respect to the peak intensity derived from each crystal face of the MFI type zeolite crystal, obtained by X-ray diffraction (XRD) measurement using a first X-ray diffractometer, the value obtained by dividing (a peak intensity derived from 002 face) by (a peak intensity derived from 020 face), i.e., (a peak intensity derived from 002 face)/(a peak intensity derived from 020 face) is 2 or more, (a peak intensity derived from 002 face)/(a peak intensity derived from 101 face) is 0.5 to 1.5, (a peak intensity derived from 101 face)/(a peak intensity derived from 501 face) is 1.5 or more, and (a peak intensity derived from 303 face)/(a peak intensity derived from 501 face) is 2 or more.
[3] An oriented zeolite membrane-provided structure according to [1] or [2], wherein, with respect to the peak intensity derived from each crystal face of the MFI type zeolite crystal, obtained by X-ray diffraction (XRD) measurement using the first X-ray diffractometer, the total of peak intensities derived from 001 face, 002 face, 004 face, 101 face, 102 face, 103 face, 104 face, 105 face, 202 face, 303 face and 404 face is at least two times the total of peak intensities derived from 010 face, 020 face, 040 face, 060 face, 100 face, 200 face, 400 face, 600 face and 501 face, and [Σ(peak intensities derived from 10x face) (x=1 to 5)]/(a peak intensity derived from 101 face) is 3 or more.
[4] An oriented zeolite membrane-provided structure according to [1], wherein, with respect to the peak intensity derived from each crystal face of the MFI type zeolite crystal, obtained by X-ray diffraction (XRD) measurement using a second X-ray diffractometer, the total of peak intensities derived from 001 face, 002 face, 004 face, 101 face, 102 face, 103 face, 104 face, 105 face, 202 face and 303 face is at least two times the total of peak intensities derived from 010 face, 020 face, 040 face, 051 face, 100 face, 200 face, 400 face, 301 face and 501 face.
[5] An oriented zeolite membrane-provided structure according to [1] or [4], wherein, with respect to the peak intensity derived from each crystal face of the MFI type zeolite crystal, obtained by X-ray diffraction (XRD) measurement using the second X-ray diffractometer, the value obtained by dividing (a peak intensity derived from 101 face) by (a peak intensity derived from 501 face), i.e., (a peak intensity derived from 101 face)/(a peak intensity derived from 501 face) is 1 or more and (a peak intensity derived from 101 face)/(a peak intensity derived from 020 face) is 3 or more.
[6] An oriented zeolite membrane-provided structure according to any of [1] to [5], wherein the thickness uniformity of the oriented zeolite membrane, represented by [(maximum membrane thickness−minimum membrane thickness)/(maximum membrane thickness)]×100 is 20% or less.
[7] An oriented zeolite membrane-provided structure according to any of [1] to [6], wherein the oriented zeolite membrane is a separation membrane for separating ethanol from a mixed solution of water and ethanol.

According to the oriented zeolite membrane-provided structure of the present invention, the proportion of zeolite crystals whose c-axes are oriented at an angle of 90°±33.76° relative to the surface of the support to the whole zeolite crystals constituting the membrane is 90% or more, and the oriented zeolite membrane has a thickness of 1 to 30 μm. Therefore, when the oriented zeolite membrane-provided structure is used as a water/ethanol separation membrane, ethanol can be separated from water in a short time with high separation efficiency. The oriented zeolite membrane-provided structure can suitably be used, in particular, as a separation membrane for separation of ethanol from water by a pervaporation method.

### BRIEF DESCRIPTION OF THE DRAWINGS

FIG. 1 is a sectional view schematically showing a state in which a support and silica sol are put in a pressure-resistant vessel in Example 1.

FIG. 2 is a SEM photograph showing a state in which zeolite seed crystal grains are precipitated on a support in Example 1.

FIG. 3 is a sectional SEM photograph showing a state in which an oriented zeolite membrane is formed on a support in Example 1.

FIG. 4 is a sectional SEM photograph showing a state in which a zeolite membrane is formed on a support in Comparative Example 1.

FIG. 5 is a graph showing the results of X-ray diffraction measurement of the oriented zeolite membrane obtained in Example 1 and the zeolite membrane obtained in Comparative Example 1.

FIG. 6 is a schematic drawing showing an entire apparatus for conducting a pervaporation test.

FIG. 7 is a perspective view schematically showing an MFI type zeolite crystal.

FIG. 8 is a schematic view showing a state in which MFI type zeolite crystal grains are oriented in particular directions relative to the surface of support.

FIG. 9 shows an embodiment (monolithic shape) of the support used in the present process for producing a zeolite membrane. FIG. 9(a) is a perspective view and FIG. 9(b) is a plan view.

FIG. 10 is a sectional view showing a state in which a support is fixed to a pressure-resistant vessel and a seeding sol or a membrane-forming sol is put in the vessel in Example or Comparative Example.

FIG. 11 is SEM photographs showing the surface of the oriented zeolite membrane formed on the surface of a support in Example 2. FIG. 11(a) is a SEM photograph which is magnified 1,500 times, and FIG. 11(b) is a SEM photograph which is magnified 150 times.

FIG. 12 is a sectional SEM photograph showing a state in which an oriented zeolite membrane is formed on the surface of a support in Example 2.

FIG. 13 is SEM photographs showing the surface of the oriented zeolite membrane formed on the surface of a support in Example 3. FIG. 13(a) is a SEM photograph which is magnified to 1,500 times, and FIG. 13(b) is a SEM photograph which is magnified to 150 times.

FIG. 14 is a sectional SEM photograph showing a state in which an oriented zeolite membrane is formed on the surface of a support in Example 3.

FIG. 15 is a SEM photograph showing the surface of the zeolite membrane formed on the surface of a support in Comparative Example 2.

FIG. 16 is a sectional SEM photograph showing a state in which an oriented zeolite membrane is formed on the surface of a support in Comparative Example 2.

FIG. 17 are graphs showing the results of X-ray diffraction measurement of (oriented) zeolite membranes. FIG. 17(a) is a graph of the oriented zeolite membrane of Example 2, FIG. 17(b) is a graph of the oriented zeolite membrane of Example 3, and FIG. 17(c) is a graph of the zeolite membrane of Comparative Example 2.

### EXPLANATION OF SYMBOLS

1: pressure-resistant vessel; 2: alumina support; 3: seeding sol; 3′: membrane-forming sol; 4: fluororesin inner cylinder; 5, 6: fixation jig; 11: zeolite seed crystal; 12: oriented zeolite membrane; 13: zeolite membrane; 21: raw material tank; 22: feeding pump; 23: feed solution inlet; 24: feed solution outlet; 25: SUS module; 26: raw material side space; 27: permeation side space; 28: oriented zeolite membrane; 29: flow meter; 30: permeating vapor collection port; 31: liquid nitrogen trap; 32: pressure regulator; 33: vacuum pump; 41, 41a, 41b, 41c: MFI type zeolite crystal; 42: abc crystal axis system; 43: surface of support; 44a, 44b, 44c: c-axis; 51: support; 52: channel; 53: axial direction; 54: porous material; 61: pressure-resistant vessel; 62: inner cylinder; 63: stainless steel vessel; 64: fixation jig; 65: porous alumina support; 66: seeding sol; 66′: membrane-forming sol; 71: oriented zeolite membrane; 72: zeolite membrane.

### BEST MODE FOR CARRYING OUT THE INVENTION

The best mode for carrying out the present invention is described below specifically. However, the present invention is in no way restricted to the following embodiment and it should be construed that design change, improvement, etc., can be made appropriately based on the ordinary knowledge possessed by those skilled in the art unless there is no deviation from the gist of the present invention.

The oriented zeolite membrane-provided structure of the present invention comprises a support and a membrane-like, MFI type zeolite crystal (an oriented zeolite membrane) provided on the surface of the support, wherein, in the zeolite crystal, the proportion of zeolite crystals whose c-axes are oriented at an angle of 90°±33.76° relative to the surface of the support is 90% or more of the total zeolite crystals, and the oriented zeolite membrane has a thickness of 1 to 30 μm. Each constituent element of the present invention is described in detail below.

### (I) Oriented Zeolite Membrane

The oriented zeolite membrane constituting the oriented zeolite membrane-provided structure of the present invention has a membrane-like, MFI type zeolite crystal. The oriented zeolite membrane constituting the oriented zeolite membrane-provided structure of the present invention is preferably composed of 100% by mass of the membrane-like, MFI type zeolite crystal but may contain impurities which are contained inevitably. In the MFI type zeolite crystal (hereinafter, this may be referred to simply as “zeolite crystal”) of the oriented zeolite membrane constituting the oriented zeolite membrane-provided structure of the present invention, the proportion of MFI type zeolite crystals whose c-axes are oriented at an angle of 90°±33.76° relative to the surface of the support is 90% or more of the total MFI type zeolite crystals, and the oriented zeolite membrane has a thickness of 1 to 30 μm.

The oriented zeolite membrane constituting the oriented zeolite membrane-provided structure of the present invention is constituted as above; therefore, when the membrane is used as a water/ethanol separation membrane, ethanol can be separated from water in a short time with high separation efficiency. The membrane can suitably be used, in particular, as a separation membrane for separation of ethanol from water by a pervaporation method.

### (I-1) Orientation of Crystal Axes

As described above, in the MFI type zeolite crystal of the oriented zeolite membrane constituting the oriented zeolite membrane-provided structure of the present invention, the proportion of MFI type zeolite crystals whose c-axes are oriented at an angle of 90°±33.76° relative to the surface of the support (c-axis orientation) is 90% or more of the total MFI type zeolite crystals and is more preferable when it is closer to 100%. When the proportion is at such a level and the membrane is used as a water/ethanol separation membrane, ethanol can be allowed to permeate the membrane efficiently. The membrane can suitably be used, in particular, as a separation membrane for separation and concentration of ethanol by a pervaporation method. Here, the angle of the c-axis relative to the surface of support refers to an acute angle or a right angle, formed by the c-axis and the surface of support. The proportion of zeolite crystals having c-axis orientation is preferably 75% or more, particularly preferably 90% or more of the total zeolite crystals. When the proportion is at such a level and the membrane is used as a water/ethanol separation membrane, ethanol can be allowed to permeate the membrane efficiently. When the proportion of zeolite crystals having c-axis orientation is less than 90%, the efficiency of ethanol separation is inferior. Incidentally, the proportion of c-axis orientation is calculated from the result of observation of membrane using a scanning electron microscope (SEM).

The orientation of each crystal axis (a-axis, b-axis or c-axis) of orientated zeolite membrane can be obtained by measurement of X-ray diffraction (XRD). Specifically, the orientation can be obtained by comparing the peak intensity derived from the crystal face or crystal axis oriented in a direction vertical to the surface of support with the peak intensity derived from another direction. As the apparatus for measurement of X-ray diffraction, there was used Mini Flex (first X-ray diffractometer) manufactured by Rigaku Corporation, and the measurement conditions were X-ray source: CuK_{α}, tube current: 30 kV, tube voltage: 15 mA, filter: Ni, and scanning speed: 4°/min.

### (I-2-1) Orientation 1 of Crystal Face

In the oriented zeolite membrane constituting the oriented zeolite membrane-provided structure of the present invention, the crystal axes of zeolite crystals are oriented as above. In addition, it is preferred that particular crystal faces have the following orientation.

That is, in the oriented zeolite membrane constituting the oriented zeolite membrane-provided structure of the present invention, with respect to the peak intensity derived from each crystal face obtained by X-ray diffraction (XRD) measurement using the first X-ray diffractometer, the value obtained by dividing (a peak intensity derived from 002 face) by (a peak intensity derived from 020 face), i.e., (a peak intensity derived from 002 face)/(a peak intensity derived from 020 face) is preferably 2 or more, more preferably 3 to 10⁵. Also, (a peak intensity derived from 002 face)/(a peak intensity derived from 101 face) is preferably 0.5 to 1.5. Also, (a peak intensity derived from 101 face)/(a peak intensity derived from 501 face) is preferably 1.5 or more, more preferably 2 to 10⁵. Also, (a peak intensity derived from 303 face)/(a peak intensity derived from 501 face) is preferably 2 or more, more preferably 3 to 10⁵. Since the particular crystal faces are in the above relations, the oriented zeolite membrane constituting the present invention, when used as a water/ethanol separation membrane, allows of efficient permeation of ethanol.

(A peak intensity derived from 002 face)/(a peak intensity derived from 020 face), of 2 or more indicates that the proportion of zeolite crystals whose b-axes are oriented vertically to the surface of support is small and that the proportion of crystals whose 002 faces are oriented parallel to the surface of support is large. When the ratio of the peak intensity derived from 002 face is small, separation performance for ethanol may be low. In addition, (a peak intensity derived from 002 face)/(a peak intensity derived from 101 face) of 0.5 to 1.5 indicates that the proportion of crystals whose 101 faces are oriented parallel to the surface of support is about the same as the proportion of zeolite crystals whose c-axes are oriented vertically to the surface of support (c-axis orientation). Further, (a peak intensity derived from 101 face)/(a peak intensity derived from 501 face) of 1.5 or more and (a peak intensity derived from 303 face)/(a peak intensity derived from 501 face) of 2 or more indicate that the proportion of crystals whose 101 faces (303 faces) are oriented parallel to the surface of support is large as compared to the proportion of zeolite crystals whose a-axes are oriented almost vertically (slanted by the angle of 501 face) to the surface of support. When the ratio of the peak intensity derived from 101 face (303 face) is smaller than the above range, separation performance for ethanol may be low. The oriented zeolite membrane constituting the present invention, when having such characteristics regarding the orientation of crystal faces, can suppress permeation of water, allows for efficient permeation of ethanol, and shows a high separation performance for water and ethanol. The membrane shows a high performance particularly as a separation membrane used when ethanol is separated from a mixed solution of water and ethanol by a pervaporation method. The first X-ray diffractometer is Mini Flex manufactured by Rigaku Corporation, and the measurement conditions are preferably the same as in measurement of the above orientation of crystal axes.

The oriented zeolite membrane constituting the present invention contains crystals of c-axis orientation in a large amount, as mentioned above. Meanwhile, the X-ray diffraction pattern of a powdery MFI zeolite is shown, for example, in “Acta Crystallogr., B43, 127-132 (1987); On the location and disorder of the tetrapropylammonium (TPA) ion in zeolite ZSM-5 with improved framework accuracy; van Koningsveld, H., van Bekkum, H. and Jansen, J. C.”. In the pattern, a peak derived from 101 face and a peak derived from 501 face appear each at a high intensity. This is a pattern which appears when a powdery crystal is in a random orientation and is largely different from the crystal of c-axis orientation.

Also, in the oriented zeolite membrane constituting an oriented zeolite membrane-provided structure of the present invention, with respect to the peak intensity derived from each crystal face obtained by X-ray diffraction (XRD) measurement using the first X-ray diffractometer, the total of peak intensities derived from 001 face, 002 face, 004 face, 101 face, 102 face, 103 face, 104 face, 105 face, 202 face, 303 face and 404 face is preferably two times or more, more preferably 3 times or more the total of peak intensities derived from 010 face, 020 face, 040 face, 060 face, 100 face, 200 face, 400 face, 600 face and 501 face. At the same time, [Σ(peak intensities derived from 10x face) (x=1 to 5)]/(a peak intensity derived from 101 face) is preferably 3 times or more, more preferably 4 times or more. The XRD peak intensities derived from particular crystal faces are in such relationships; therefore, the membrane can suppress permeation of water, allows of efficient permeation of ethanol, and shows high separation performance for water and ethanol. The membrane shows a high performance particularly as a separation membrane used when ethanol is separated from a mixed solution of water and ethanol by a pervaporation method. When the total of peak intensities derived from 001 face, 002 face, 004 face, 101 face, 102 face, 103 face, 104 face, 105 face, 202 face, 303 face and 404 face is smaller than the above-mentioned range, separation performance for ethanol may be low. Here, [Σ(peak intensities derived from 10x face) (x=1 to 5)] indicates the total of peak intensities derived from 101 face, 102 face, 103 face, 104 face and 105 face; and [Σ(peak intensities derived from 10x face) (x=1 to 5)]/(a peak intensity derived from 101 face) indicates a value obtained by dividing [Σ(peak intensities derived from 10x face) (x=1 to 5)] by (a peak intensity derived from 101 face).

### (I-2-2) Orientation 2 of Crystal Face

When the oriented zeolite membrane (MFI type zeolite crystal) constituting an oriented zeolite membrane-provided structure of the present invention is subjected to X-ray diffraction (XRD) measurement using a second X-ray diffractometer shown below, it is preferred that particular crystal faces have the following orientations.

That is, with respect to the peak intensity derived from each crystal face obtained by the X-ray diffraction (XRD) measurement using a second X-ray diffractometer, the total of peak intensities derived from 001 face, 002 face, 004 face, 101 face, 102 face, 103 face, 104 face, 105 face, 202 face and 303 face is preferably 2 times or more, more preferably 4 times or more the total of peak intensities derived from 010 face, 020 face, 040 face, 051 face, 100 face, 200 face, 400 face, 301 face and 501 face. The XRD peak intensities derived from particular crystal faces are in such relationships; therefore, the membrane can suppress permeation of water, allows of efficient permeation of ethanol, and shows a high separation performance for water and ethanol. The membrane shows high performance particularly as a separation membrane used when ethanol is separated from a mixed solution of water and ethanol by a pervaporation method. When the total of peak intensities derived from 001 face, 002 face, 004 face, 101 face, 102 face, 103 face, 104 face, 105 face, 202 face and 303 face is smaller than the above range, the separation performance for ethanol may be low. The second X-ray diffractometer is RINT-TTR III manufactured by Rigaku Corporation. The measurement conditions using the diffractometer are preferably X-ray source: CuK_{α}, tube current: 50 kV, tube voltage: 300 mA, scanning axis: 2θ/θ, scanning mode: continuous, sampling width: 0.02°, scanning speed: 1°/min, diverging slit: 1.0 mm, diverging vertical slit: 10 mm, scattering slit: open, light-receiving slit: open, and opening angle of long solar slit: 0.114°.

Also, in the oriented zeolite membrane (MFI type zeolite crystal) constituting the oriented zeolite membrane-provided structure of the present invention, with respect to the peak intensity derived from each crystal face, obtained by X-ray diffraction (XRD) measurement using the second X-ray diffractometer, the value obtained by dividing (a peak intensity derived from 101 face) by (a peak intensity derived from 501 face), i.e., (a peak intensity derived from 101 face)/(a peak intensity derived from 501 face) is preferably 1 or more, more preferably 4 or more. Also, (a peak intensity derived from 101 face)/(a peak intensity derived from 020 face) is preferably 3 or more, more preferably 8 or more. Since the particular crystal faces are in the above relations, the oriented zeolite membrane constituting the present invention, when used as a water/ethanol separation membrane, allows of efficient permeation of ethanol.

(A peak intensity derived from 101 face)/(a peak intensity derived from 501 face) of 1 or more indicates that the proportion of crystals whose 101 faces are oriented parallel to the surface of support is large as compared to the proportion of zeolite crystals whose a-axes are oriented almost vertically (slanted by the angle of 501 face) to the surface of support. When the proportion of peak intensities derived from 101 faces is smaller than the above range, the separation performance for ethanol may be low. (A peak intensity derived from 101 face)/(a peak intensity derived from 020 face) of 3 or more indicates that the proportion of zeolite crystals whose b-axes are oriented vertically to the surface of support is small, and the proportion of crystals whose 101 faces are oriented parallel to the surface of support is large. When the ratio of the peak intensities derived from 101 faces is small, the separation performance for ethanol may be low. The oriented zeolite membrane constituting the present invention, when having such characteristics regarding the orientation of crystal faces, can suppress permeation of water, allows of efficient permeation of ethanol, and shows high separation performance for water and ethanol. The membrane shows a high performance particularly as a separation membrane used when ethanol is separated from a mixed solution of water and ethanol by a pervaporation method. The conditions of the X-ray diffraction (XRD) measurement using the second diffractometer are preferably X-ray source: CuK_{α}, tube current: 50 kV, tube voltage: 300 mA, scanning axis: 2θ/θ, scanning mode: continuous, sampling width: 0.02°, scanning speed: 1°/min, diverging slit: 1.0 mm, diverging vertical slit: 10 mm, scattering slit: open, light-receiving slit: open, and opening angle of long solar slit: 0.114°.

### (I-3) Membrane Thickness

The oriented zeolite membrane constituting the oriented zeolite membrane-provided structure of the present invention has a thickness of 1 to 30 μm, preferably 1 to 20 μm, particularly preferably 1 to 15 μm. When the membrane has a thickness smaller than 1 μm and used for separation of ethanol from a mixed solution of water and ethanol, the permeation amount of water is large, making the separation efficiency low. When the thickness is larger than 30 μm, the permeation rate of ethanol is small, requiring a long time for separation by membrane. Here, the thickness of oriented zeolite membrane is a value obtained by observing the section of oriented zeolite membrane using a scanning electron microscope (SEM), and “a membrane thickness of 1 to 30 μm” means that the minimum membrane thickness is 1 μm or more and the maximum membrane thickness is 30 μm or less.

The oriented zeolite membrane constituting the oriented zeolite membrane-provided structure of the present invention preferably has a uniform thickness. With a uniform thickness, even an oriented zeolite membrane is formed in a small thickness, for example, no portion or the like which is too small in thickness formed; and such a membrane, when used for permeation of ethanol or the like, allows of uniform permeation in all the surface of oriented zeolite membrane. Also, defects, etc., appear hardly in the oriented zeolite membrane. The degree of thickness uniformity of oriented zeolite membrane is judged by the SEM image of the section of oriented zeolite membrane and can be shown by a formula of uniformity, represented by [(maximum membrane thickness−minimum membrane thickness)/(maximum membrane thickness)]×100 (%). A smaller value of the formula indicates a higher uniformity. The uniformity is preferably 20% or less, more preferably 1 to 10%, particularly preferably 1 to 5%. A higher uniformity is preferred.

Also, the oriented zeolite membrane constituting the oriented zeolite membrane-provided structure of the present invention is preferably dense. When there is used a dense separation membrane, there is no passing of a mixed solution through the gaps between zeolite crystals and efficient separation can take place in the whole surface of membrane. Here, being dense refers to a state in which there is no exposure of support surface upon observation using a scanning electron microscope (SEM).

### (I-4) Support

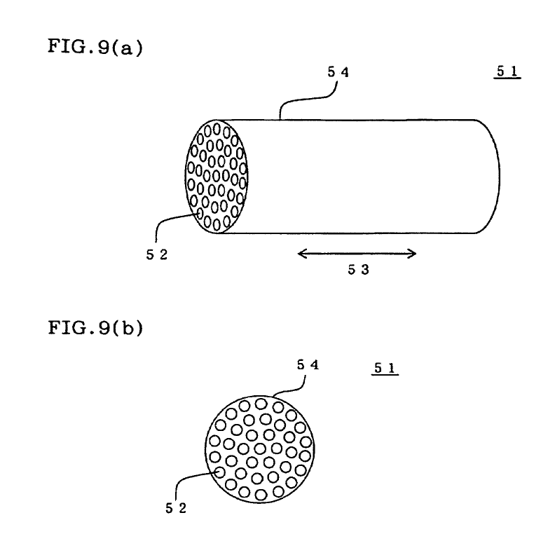

The oriented zeolite membrane-provided structure of the present invention has a support and an oriented zeolite membrane provided thereon. Therefore, the oriented zeolite membrane, even when being a thin membrane, is sustained by the support to maintain its shape and can be protected from breakage, etc. As to the support, there is no particular restriction as long as it allows of generation of zeolite seed crystal thereon and subsequent formation of oriented zeolite membrane. The material, shape and size of the support can appropriately be determined depending upon the application, etc., of the zeolite membrane formed. As the material constituting the support, there can be mentioned ceramics such as alumina (e.g., α-alumina, γ-alumina or anode oxidation alumina) and zirconia; metals (e.g., stainless steel); and so forth. Alumina is preferred from the standpoint of easiness of support production or easiness of alumina procurement. As the alumina, there is preferred one obtained by forming and sintering alumina particles (raw material) having an average particle diameter of 0.001 to 30 μm. The support is preferably porous. The shape of the support may be any of plate, circular cylinder, tube of polygonal section, monolithic shape, spiral shape, etc., but a monolithic shape is preferred. Here, the monolithic shape refers to a circular cylinder such as a support 51 shown in FIGS. 9(a) and 9(b), where a plurality of channels 52 are formed in parallel in the axial direction 53. FIG. 9 show an embodiment (monolithic shape) of the support used in the present process for production of zeolite membrane, where FIG. 9(a) is a perspective view and FIG. 9(b) is a plan view. The support 51 is particularly preferably a porous material 54 of monolithic shape. Such a support composed of a porous material of monolithic shape can be obtained by a known production method such as extrusion molding.

### (I-5) Separation Membrane for Ethanol

As described above, the oriented zeolite membrane constituting the oriented zeolite membrane-provided structure of the present invention can preferably be used as a separation membrane for separation of ethanol from a mixed solution of water and ethanol. The membrane shows a superior performance particularly as a separation membrane used for separation of ethanol by a pervaporation method.

For example, when the oriented zeolite membrane constituting the oriented zeolite membrane-provided structure of the present invention is used for separation of ethanol by a pervaporation method, it is possible to allow an ethanol/water mixed solution containing 3 to 20% by volume of ethanol to permeate the membrane to convert the solution into a solution containing 50 to 95% by volume of ethanol. In this case, the permeation flux may be 1 to 8 kg/m²·hour and the separation coefficient may be 15 to 80. Here, the permeation flux is a mass of all substances which permeated the membrane per unit time (hour) and unit area (m²); and the separation coefficient is, as shown in the following formula, a value obtained by dividing a ratio of ethanol concentration (volume %) to water concentration (volume %) in solution after permeation by a ratio of ethanol concentration (volume %) to water concentration (volume %) in feed solution.

Separation coefficient=[(ethanol concentration in after-permeation solution)/(water concentration in after-permeation solution)]/[(ethanol concentration in feed solution)/(water concentration in feed solution)]

### (II) Production Process

The oriented zeolite membrane-provided structure of the present invention is produced preferably by a process for producing an oriented zeolite membrane-provided structure, which comprises:

a seed crystal generation step of placing, in a pressure-resistant vessel, a seeding sol containing silica, water and a structure-defining agent and a support in a state that the support is immersed in the seeding sol and heating the heat-resistant vessel to generate a zeolite seed crystal on the surface of the support, and

a membrane formation step of allowing the zeolite seed crystal to grow to form an oriented zeolite membrane on the surface of the support,

wherein, in the seed crystal generation step, the molar ratio of water/silica in the seeding sol is set at water/silica=10 to 50 and the heating of the pressure-resistant vessel is conducted at 90 to 130° C. By producing an oriented zeolite membrane-provided structure by such a production process, there can be produced an oriented zeolite membrane-provided structure where, in the zeolite crystal constituting the oriented zeolite membrane, the proportion of zeolite crystals whose c-axes are oriented at an angle of 90°±33.76° relative to the surface of the support is 90% or more of the total zeolite crystals, and the oriented zeolite membrane has a thickness of 1 to 30 μm.

### (II-1) Seed Crystal Generation Step

### (II-1-1) Seeding Sol

The seeding sol used in a process for producing an oriented zeolite membrane-provided structure of the present invention is a silica sol having fine silica particles dispersed in water and contains therein at least a structure-defining agent. This seeding sol is obtained by mixing a silica sol of given concentration, water for concentration adjustment, and an aqueous solution containing a given concentration of a structure-defining agent, at given amounts. This seeding sol is crystallized, by a hydrothermal treatment described later, into a zeolite having a structure in which silica atoms derived from the silica sol surround the circumference of the molecule of the structure-defining agent. The structure-defining agent is removed from the above structure by a heat treatment described later to form a zeolite crystal having pores of specific shape determined by the structure-defining agent.

As the silica sol, there can preferably be used a commercial silica sol [for example, Snowtex S (trade name), a product of Nissan Chemical Industries, ltd., solid content: 30 mass %]. Here, the solid refers to silica. There may also be used a silica sol obtained by dissolving a fine silica powder in water, or a silica sol obtained by hydrolyzing an alkoxysilane.

In the seeding sol, the molar ratio of contained water and silica (fine particles) (water/silica molar ratio: a value obtained by diving the number of moles of water by the number of moles of silica) is preferably water/silica=10 to 50, more preferably 20 to 40. By thus setting the silica concentration in seeding sol at a high level, it is possible to allow a zeolite seed crystal to adhere on the surface of a support in the form of fine particles. When the water/silica molar ratio is smaller than 10, the zeolite seed crystal may precipitate on the surface of a support non-uniformly and excessively. When the molar ratio is larger than 50, there may be no precipitation of zeolite seed crystal on the surface of a support. Here, the state in which the zeolite seed crystal adheres on the surface of a support can be indicated quantitatively in, for example, a scanning electron microscope (SEM) photograph as a proportion of crystal-covering area to the support surface (a covered area proportion in photograph), and the proportion of covered area is preferably 5 to 100%.

As the structure-defining agent for MFI type zeolite, there can be used tetrapropylammonium hydroxide (TPAOH) and tetrapropylammonium bromide (TPABr), both capable of generating tetrapropylammonium ion (TPA). Therefore, as the aqueous solution of structure-defining agent, there can preferably be used an aqueous solution containing TPAOH and/or TPABr.

As the silica sol, there is also used preferably a sol containing, besides fine silica particles, a hydroxide of alkali metal or alkaline earth metal. Although the TPAOH used as a structure-defining agent for MFI type zeolite is a relatively expensive reagent, there can be obtained, according to this process, a TPA source and a an alkali source from TPABr of relatively low cost and a hydroxide of alkali metal or the like. That is, in this process, the use amount of expensive TPAOH can be lowered, which allows of reduction in raw material cost and inexpensive production of zeolite.

The mixing of the silica sol and the structure-defining agent is conducted in a molar ratio of TPA relative to silica (TPA/silica ratio), of preferably 0.05 to 0.5, more preferably 0.1 to 0.3. When the TPA/silica ratio is less than 0.05, there may be no precipitation of seed crystal; when the TPA/silica ratio is more than 0.5, there may be excessive precipitation of seed crystal on the surface of support.

The water added during preparation of seeding sol is preferably free from impurity ions, and specifically preferred is distilled water or an ion exchange water.

### (II-1-2) Support

The support is preferably the same as used for supporting the oriented zeolite membrane-provided structure of the present invention. That is, there is no particular restriction as to the support as long as it allows of generation of zeolite seed crystal thereon and subsequent formation of oriented zeolite membrane. The material, shape and size of the support can appropriately be determined depending upon the application, etc., of the zeolite membrane formed. As the material constituting the support, there can be mentioned ceramics such as alumina (e.g., α-alumina, γ-alumina or anode oxidation alumina), zirconia and the like; metals (e.g. stainless steel); and so forth. Alumina is preferred from the standpoint of easiness of support production or easiness of alumina procurement. As the alumina, there is preferred one obtained by forming and sintering of alumina particles (raw material) having an average particle diameter of 0.001 to 30 μm. The shape of the support may be any of plate, circular cylinder, tube of polygonal section, monolithic shape, spiral shape, etc.

### (II-1-3) Generation of Zeolite Seed Crystal

In order to generate a zeolite seed crystal, first, the support and the seeding sol are put in a pressure-resistant vessel. At this time, the support is arranged so as to be immersed in the seeding sol. Then, the pressure-resistant vessel is heated to convert the water in the pressure-resistant vessel into steam and give rise to a hydrothermal synthesis to generate a zeolite seed crystal on the surface of the support.

As the pressure-resistant vessel, there is no particular restriction. However, there can be used, for example, a stainless steel pressure-resistant vessel having a fluororesin inner cylinder or a nickel metal pressure-resistant vessel. When the support is immersed in the seeding sol, it is preferred that at least the portion of the support on which a zeolite seed crystal is to be precipitated is immersed in the seeding sol, or the whole support may be immersed in the seeding sol. The temperature at which a hydrothermal synthesis is conducted is 90 to 130° C., preferably 100 to 120° C. When the temperature is lower than 90° C., the hydrothermal synthesis is unlikely to proceed, and, when the temperature is higher than 130° C., it is impossible to obtain a zeolite seed crystal in fine grains. Particularly when the support is a porous material obtained by sintering alumina particles, setting of the hydrothermal synthesis temperature at the above range (90 to 130° C.) makes it possible to cover the surface of each alumina particle present on the surface of the support, with zeolite seed grains. The time of the hydrothermal synthesis is preferably 3 to 18 hours, more preferably 6 to 12 hours. When the hydrothermal synthesis time is shorter than 3 hours, the hydrothermal synthesis may not proceed sufficiently, and, when the time is longer than 18 hours, the zeolite seed crystal generated may be too large. By thus precipitating the zeolite seed crystal directly on the surface of the support by hydrothermal synthesis, the zeolite seed crystal obtained is hardly peeled from the support; therefore, when an oriented zeolite membrane is formed thereon, problems such as a defect of membrane, non-uniformity of membrane thickness, and the like can be inhibited.

As the method for heating, there can be mentioned, for example, a method of putting a pressure-resistant vessel in a hot-air dryer to conduct heating, and a method of fixing a heater directly to a pressure-resistant vessel to conduct heating.

The grain diameter of the zeolite seed crystal obtained is preferably as small as possible. Specifically, the grain diameter is preferably 1 μm or less, more preferably 0.5 μm or less, particularly preferably 0.01 to 0.5 μm. When the grain diameter is larger than 1 μm, it may be impossible to form, in the membrane formation step, an oriented zeolite membrane which has little defects, has a uniform thickness and is dense. Here, the grain diameter of the zeolite seed crystal is a value obtained by observation using a scanning electron microscope (SEM), and a grain diameter of 1 μm or less refers to that the maximum grain diameter is 1 μm or less.

After the precipitation of the zeolite seed crystal on the surface of the support, the support is preferably washed by boiling water. Thereby, formation of excessive zeolite can be prevented. The time of washing is not particularly restricted as long as the seeding sol can be washed away; however, it is preferred to repeat washing of 0.5 to 3 hours 1 to 5 times. After the washing, drying is preferably conducted at 60 to 120° C. for 4 to 48 hours.

### (II-2) Membrane Formation Step

### (II-2-1) Membrane-Forming Sol

The membrane-forming sol is preferably a sol which uses the same raw materials as in the seeding sol, i.e. a silica sol, a structure-defining agent and water and wherein the water is used in a larger amount than in the seeding sol and resultantly the concentration is lower than in the seeding sol.

In the membrane-forming sol, the molar ratio of the contained water and the silica (fine particles), i.e. the water/silica molar ratio is preferably water/silica=100 to 700, more preferably 200 to 500. When the water/silica molar ratio is 100 to 700, there can be formed an oriented zeolite membrane which has a uniform thickness, has little defects, and is dense, and it is possible to control the thickness of oriented zeolite membrane at a desired level. When the water/silica molar ratio is smaller than 100, the silica concentration is high, and a zeolite crystal settles out in the membrane-forming sol and is precipitated on the surface of the oriented zeolite membrane formed; therefore, cracks, etc., may easily appear during the activation treatment (e.g. firing). When the water/silica molar ratio is larger than 700, the oriented zeolite membrane may not be dense.

With respect to the membrane-forming sol, the mixing of the silica sol and the aqueous solution of structure-defining agent is conducted so that the molar ratio of TPA to silica (TPA/silica ratio) is in a range of preferably 0.01 to 0.5, more preferably 0.02 to 0.3. When the TPA/silica ratio is less than 0.01, the membrane is hardly dense and, when the ratio is more than 0.5, there may be deposition of zeolite crystal on the membrane.

### (II-2-2) Membrane Formation

The zeolite seed crystal precipitated on the surface of the support is allowed to grow by a hydrothermal synthesis, whereby an oriented zeolite membrane composed of zeolite crystals grown in a membrane shape is formed on the surface of the support. In order to form an oriented zeolite membrane on the surface of the support, first, there are placed, in a pressure-resistant vessel, the support having a zeolite seed crystal precipitated thereon and the above-mentioned membrane-forming sol, as in the above-mentioned case of generating (precipitating) a zeolite seed crystal. At this time, the support is arranged so as to be immersed in the membrane-forming sol. Then, the pressure-resistant vessel is heated to give rise to a hydrothermal synthesis to form an oriented zeolite membrane on the surface of the support. Incidentally, since the oriented zeolite membrane obtained by the hydrothermal synthesis contains tetrapropylammonium, a heat treatment is preferably conducted after the membrane formation, in order to obtain a final oriented zeolite membrane.

As the pressure-resistant vessel, there is preferably used the same pressure-resistant vessel as used in the generation of zeolite seed crystal. When the support is immersed in the membrane-forming sol, it is preferred that at least the portion on which an oriented zeolite membrane is to be formed of the support is immersed in the seeding sol. The whole support may be immersed in the seeding sol. The temperature at which the hydrothermal synthesis is conducted is preferably 100 to 200° C., more preferably 120 to 180° C. By employing such a temperature range, there can be obtained an oriented zeolite membrane which has a uniform thickness, has little defects and is dense. In the present process for production of oriented zeolite membrane-provided structure, a membrane of such high quality can be produced at a good reproducibility, and the production efficiency is high. When the temperature is lower than 100° C., the hydrothermal synthesis may proceed hardly, and, when the temperature is higher than 200° C., there may hardly be obtained an oriented zeolite membrane which has a uniform thickness, has little defects and is dense. The time of the hydrothermal synthesis is preferably 3 to 120 hours, more preferably 6 to 90 hours, particularly preferably 10 to 72 hours. When the time is shorter than 3 hours, the hydrothermal synthesis may not proceed sufficiently, and, when the time is longer than 120 hours, the oriented zeolite membrane obtained may have a non-uniform and too large thickness. Here, dense, oriented zeolite membrane refers to a state that, when observation is made by a scanning electron microscope (SEM), there is no exposure of support surface. The defects of oriented zeolite membrane can be examined, for example, by coating a coloring agent (e.g. a Rhodamine B solution) on the surface of the support, quickly conducting water-washing, and observing the remaining color visually. Little defects refer to a state that there is substantially no remaining color.

The thickness of the oriented zeolite membrane obtained is preferably 30 μm or less, more preferably 1 to 30 μm, particularly preferably 1 to 20 μm, most preferably 1 to 15 μm. When the thickness is larger than 30 μm, the oriented zeolite membrane, when used as a separation membrane, may show a low separation efficiency. Here, the thickness of the oriented zeolite membrane is a value obtained by observation using a scanning electron microscope (SEM). Since such a thin membrane can be formed, a separation membrane can be obtained which has little defects, has a uniform thickness and is dense as described above and further has a high separation performance.

In the oriented zeolite membrane obtained, the c-axes of zeolite crystals are oriented vertically relative to the surface of the support (c-axis orientation). In the zeolite crystal, the proportion of zeolite crystals whose c-axes are oriented at an angle of 90°±33.76° relative to the surface of the support is 90% or more of the total zeolite crystals. That is, the oriented zeolite membrane obtained by the above process is the oriented zeolite membrane constituting the oriented zeolite membrane-provided structure of the present invention and satisfies the properties of the oriented zeolite membrane constituting the present invention. The zeolite membrane obtained by the production process of the present invention can be used for separation not only from a water-ethanol mixed solution but also from a mixture containing other low-molecular substance.

After the formation of an oriented zeolite membrane on the surface of a support by a hydrothermal synthesis, the support is preferably washed by boiling water. Thereby, deposition of excessive zeolite crystal on the oriented zeolite membrane can be prevented. The time of washing is not particularly restricted, but it is preferred to repeat washing of 0.5 to 3 hours 1 to 5 times. After the washing, it is preferred to conduct drying at 60 to 120° C. for 4 to 48 hours.

Next, the oriented zeolite membrane formed on the support surface by the above process is subjected to a heat treatment (activation treatment) to remove tetrapropylammonium to obtain a final, oriented zeolite membrane. The temperature of the heating is preferably 400 to 600° C., and the time of the heating is preferably 1 to 60 hours. As the apparatus used for the heating, an electric furnace or the like can be mentioned.

### EXAMPLES

The present invention is described more specifically below by way of Examples. However, the present invention is in no way restricted by these Examples.

### Example 1

### Preparation of Seeding Sol

36.17 g of a 40 mass % tetrapropylammonium hydroxide solution (produced by SACHEM) was mixed with 18.88 g of tetrapropylammonium bromide (produced by Wako Pure Chemical Industries, Ltd.). Thereto were added 82.54 g of distilled water and 95 g of an about 30 mass % silica sol [Snowtex S (trade name) produced by Nissan Chemical Industries, Ltd.]. The mixture was stirred at room temperature for 30 minutes using a magnetic stirrer to prepare a seeding sol.

### (Generation of Zeolite Seed Crystal)

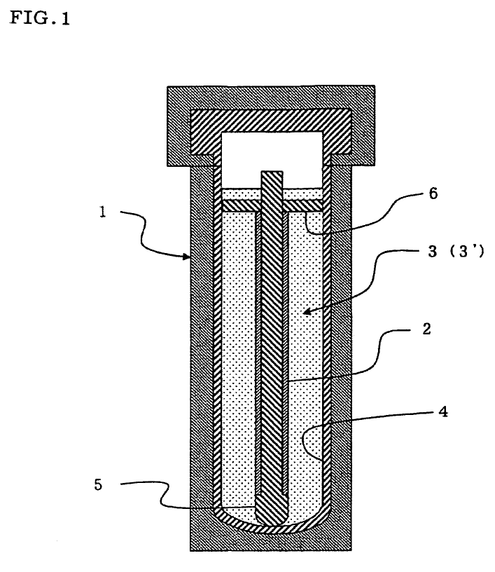

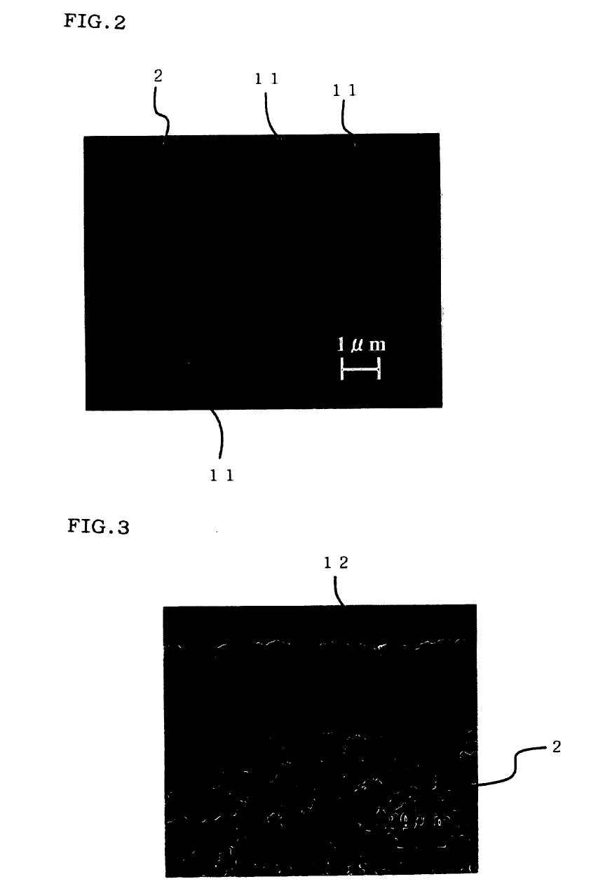

As shown in FIG. 1, the seeding sol 3 obtained was placed in a 300-ml stainless steel pressure-resistant vessel 1 having inside a fluororesin inner cylinder 4, and a cylindrical porous alumina support 2 (12 mm in diameter, 1 to 2 mm in thickness and 160 mm in length) was immersed therein. A reaction was allowed to take place for 10 hours in a hot-air drier of 110° C. The alumina support 2 was fixed inside the pressure-resistant vessel 11 using fluororesin fixation jigs 5 and 6. The support after the reaction was washed by boiling five times and then dried at 80° C. for 16 hours. The surface of the support after the reaction was observed with a scanning electron microscope (SEM). As a result, as shown in a scanning electron microscope (SEM) photograph of FIG. 2, the whole surface of the porous alumina support 2 was covered with zeolite crystal grains (a zeolite seed crystal) 11 of about 0.5 μm, with no open area. It was confirmed by the X-ray diffraction of crystal grains that the zeolite seed crystal was an MFI type zeolite.

### (Preparation of Membrane-Forming Sol)

0.66 g of a 40 mass % tetrapropylammonium hydroxide solution (produced by SACHEM) was mixed with 0.34 g of tetrapropylammonium bromide (produced by Wako Pure Chemical Industries, Ltd.). Thereto were added 229.6 g of distilled water and 5.2 g of an about 30 mass % silica sol [Snowtex S (trade name) produced by Nissan Chemical Industries, Ltd.]. The mixture was stirred at room temperature for 30 minutes using a magnetic stirrer to prepare a membrane-forming sol.

### (Formation of Oriented Zeolite Membrane (Oriented Zeolite Membrane-Provided Structure))

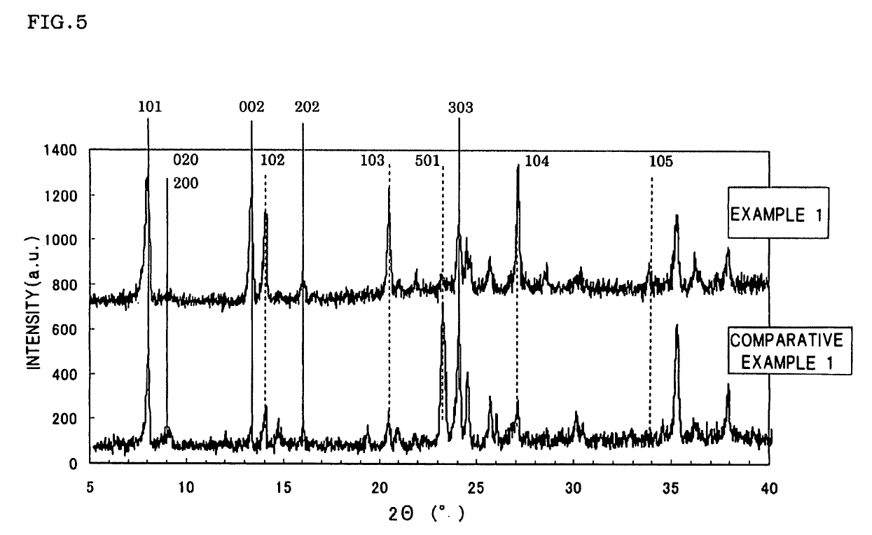

The membrane-forming sol 3′ obtained was placed in a 300-ml stainless steel pressure-resistant vessel 1 having inside a fluororesin inner cylinder 4 such as shown in FIG. 1 as in the above case of “generation of zeolite seed crystal”. The porous alumina support 2 on which the zeolite seed crystal precipitated was immersed therein. A reaction was allowed to take place for 60 hours in a hot-air drier of 180° C. The support after the reaction was washed by boiling 5 times and then dried at 80° C. for 16 hours. The section of the surface portion of the support after the reaction was observed using a scanning electron microscope (SEM). As a result, a dense layer (oriented zeolite membrane) 12 of about 13 μm in thickness was present on the surface of the porous alumina support 2, as shown in a scanning electron microscope (SEM) photograph of FIG. 3. This dense layer was subjected to analysis by X-ray diffraction (XRD) under the conditions shown below. As a result, the dense layer was confirmed to be an MFI type zeolite crystal. The result of the measurement of X-ray diffraction is shown in FIG. 5.

The MFI type zeolite membrane of c-axis orientation, formed on the porous alumina support was heated to 500° C. in an electric furnace and kept at that temperature for 4 hours to remove tetrapropylammonium to obtain an oriented zeolite membrane-provided structure in which an oriented zeolite membrane was provided on a support.

### Comparative Example 1

18.75 g of a 40 mass % tetrapropylammonium hydroxide solution (produced by SACHEM) was mixed with 9.78 g of tetrapropylammonium bromide (produced by Wako Pure Chemical Industries, Ltd.). Thereto were added 180.46 g of distilled water and 30 g of an about 30 weight % silica sol [Snowtex S (trade name), produced by Nissan Chemical Industries, Ltd.]. The mixture was stirred at room temperature for 30 minutes using a magnetic stirrer to prepare a membrane-forming sol. The sol was placed in a 300-ml stainless steel pressure-resistant vessel having inside a fluororesin inner cylinder, and a porous alumina support of 12 mm in diameter, 1 to 2 mm in thickness and 160 mm in length was immersed therein. A reaction was allowed to take place for 30 hours in a hot-air drier of 160° C. The support after the reaction was washed with hot water five times and then dried at 80° C. for 16 hours. The membrane formed had a thickness of 26 μm.

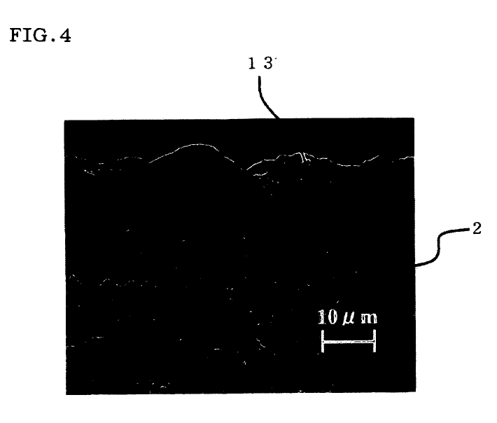

The section of the surface portion of the support of Comparative Example 1 having a zeolite membrane formed thereon was observed using a scanning electron microscope (SEM). As a result, as shown in FIG. 4 [a scanning electron microscope (SEM) photograph], there had been formed, on the surface of the porous alumina support 2, a non-uniform zeolite membrane 13 having much surface unevenness. This zeolite membrane was analyzed by X-ray diffraction under the conditions of “X-ray diffraction 1” shown later, and it was confirmed that the zeolite membrane was an MFI type zeolite crystal. The result of the measurement of X-ray diffraction is shown in FIG. 5.

Using the oriented zeolite membrane obtained in Example 1 and the zeolite membrane obtained in Comparative Example 1, a test (a permeation test) was conducted by the following method (pervaporation), for separation of ethanol from a mixed solution of water and ethanol. In the mixed solution of water and ethanol, the content of ethanol was 10% by volume.

### (X-Ray Diffraction 1)

An X-Ray Diffraction (Xrd) Pattern was Obtained by using a first X-ray diffractometer [Mini Flex manufactured by Rigaku Corporation], under the conditions of CuK_{α} (X-ray source), 30 kV (tube current), 15 mA (tube voltage), Ni (filter) and 4°/min (scanning speed). In FIG. 5, the axis of ordinate indicates intensity (a.u.), and the axis of abscissa indicates 2θ(°).

### (Pervaporation Test)

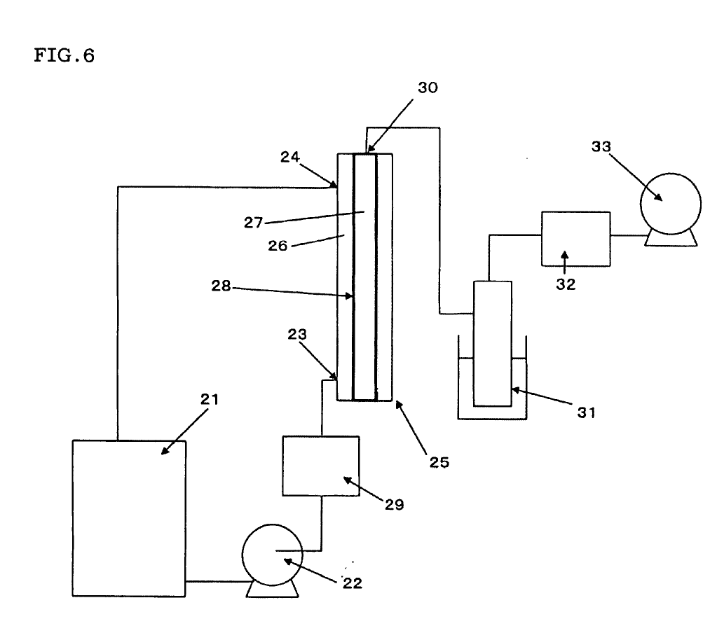

FIG. 6 is a schematic drawing showing an entire apparatus for conducting a pervaporation test. As shown in FIG. 6, an aqueous solution containing 10 volume % of ethanol, put in a raw material tank 21 is heated to about 70° C. A raw material is fed from a feed solution inlet 23 to a raw material side space 26 of a SUS (stainless steel) module 25 by a feeding pump 22 and the raw material discharged from a feed solution outlet 24 is returned to the raw material tank 21, whereby the raw material is circulated. The flow rate of the raw material is confirmed by a flow meter 29. By reducing the pressure of a space 27 on a support side of an oriented zeolite membrane 28 by a vacuum pump 33, a vapor is allowed to permeate the oriented zeolite membrane 28, discharged from an outlet 30 of vapor after permeation, and recovered in a liquid N₂ trap 31. The vacuum of the space 27 on the permeation side is controlled by a pressure regulator 32. In the SUS module 25, the inner space is divided by the oriented zeolite membrane 28 into the raw material side space 26 and the permeation side space 27; the feed solution inlet 23 and the feed solution outlet 24 are formed so as to communicate with the raw material side space 26; and the outlet 30 of after-permeation vapor for discharging outside the after-permeation vapor is formed at the top of the permeation side space 27. In FIG. 6, the SUS module 25 has such a structure that there is fitted, in a cylindrical SUS outer case, a cylindrical, oriented zeolite membrane provided on the outer surface of a cylindrical support (not shown). The mass of the liquid obtained was weighed by an electronic balance, and the composition of the liquid was analyzed by gas chromatography.

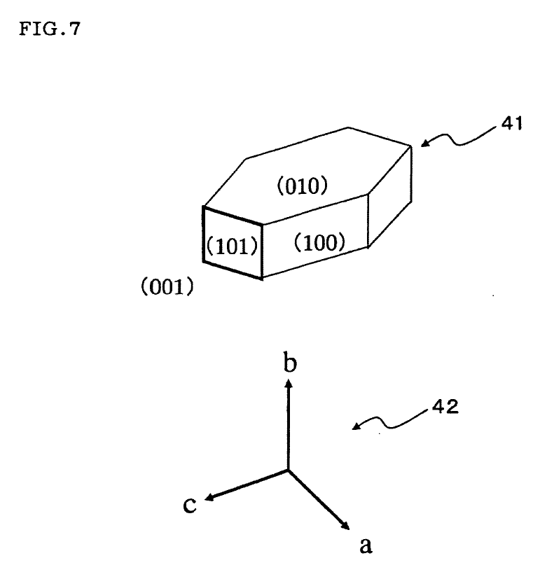

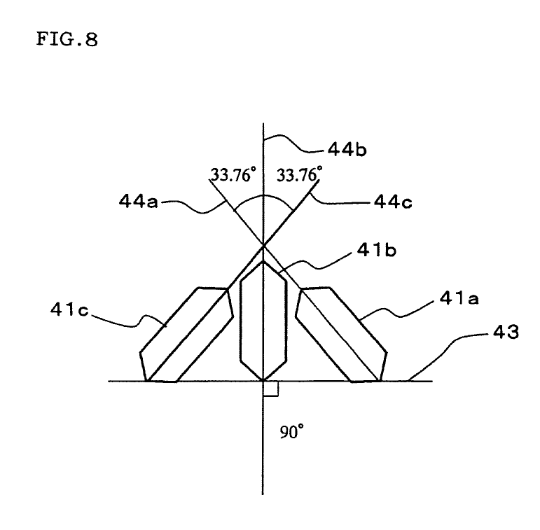

The separation coefficients and permeation fluxes (kg/m²/hour) obtained from the above pervaporation tests are shown in Table 1. Also, the relations of the particular peak intensities obtained from the X-ray diffraction patterns are shown in Tables 2 and 3. In Table 2, “c-axis” indicates the total of peak intensities derived from 001 face, 002 face, 004 face, 101 face, 102 face, 103 face, 104 face, 105 face, 202 face, 303 face and 404 face. “a-axis b-axis” indicates the total (total of total a and total b) of the total (total a) of peak intensities derived from 100 face, 200 face, 400 face, 600 face and 501 face and the total (total b) of peak intensities derived from 010 face, 020 face, 040 face and 060 face. “c-axis/a-axis b-axis” indicates the value obtained by dividing the “c-axis” by the “a-axis b-axis”. In Table 2, “Σ10x/101” indicates [Σ(peak intensities derived from 10x faces) (x=1 to 5)]/(peak intensity derived from 101 face). In Table 3, “101/020”, for example, means the value obtained by dividing the peak intensity derived from the 101 crystal face of the oriented zeolite membrane used for measurement, by the peak intensity derived from the 020 crystal face of the membrane. In FIG. 7 and FIG. 8 are shown drawings explaining an MFI type zeolite crystal and c-axis orientation. FIG. 7 is a perspective view schematically showing each crystal face in the abc crystal axis system 42 of MFI type zeolite crystal 41. FIG. 8 is a schematic drawing showing a state in which MFI type zeolite crystal grains are oriented in particular directions relative to the surface 43 of support. In the MFI type zeolite crystal grain 41a, the angle formed by the c-axis 44a and the support surface 43 is 90°±33.76° and its 101 crystal face is parallel to the support surface 43. In the MFI type zeolite crystal grain 41c, the angle formed by the c-axis 44c and the support surface 43 is 90°−33.76° and its 101 crystal face is parallel to the support surface 43. In this case, “90°+33.76°” and “90°−33.76°” are in a relative relation, and it is possible that the angle formed by the c-axis 44a and the support surface 43 is “90°−33.76°” and that the angle formed by the c-axis 44c and the support surface 43 is “90°+33.76°”. In the MFI type zeolite crystal grain 41b, the angle formed by the c-axis 44b and the support surface 43 is 90°, and its 001 crystal face is parallel to the support surface 43. Incidentally, in Reference Example of Table 2 and Table 3, there are shown the relations of peak intensities obtained by subjecting a single crystal powder MFI type zeolite of grain diameters 230×200×150 μm (c-axis direction length×a-axis direction length×b-axis direction length) to X-ray diffraction measurement. The MFI type zeolite powder of Reference Example was obtained by a hydrothermal synthesis.

TABLE 1

| | Separation | Permeation flux |
|---|---|---|
| | coefficient | (kg/m² · hour) |
| Example 1 | 69 | 3.92 |
| Comparative Example 1 | 53 | 1.38 |

TABLE 2

Peak intensity ratio

| | c-axis/a-axis b-axis | Σ10x/101 |
|---|---|---|
| Example 1 | 3.9 | 4.0 |
| Comparative Example 1 | 1.1 | 2.7 |
| Reference Example | 0.9 | 1.5 |

TABLE 3

Crystal face/crystal face
(peak intensity ratio)

| | 101/501 | 303/501 | 002/020 | 002/101 |
|---|---|---|---|---|
| Example 1 | 3.3 | 2.2 | 5.4 | 1.0 |
| Comparative | 0.4 | 0.6 | 0.6 | 0.3 |
| Example 1 | | | | |
| Reference | 0.7 | 0.5 | 0.2 | 0.1 |
| Example | | | | |

It is clear from Table 1 that the oriented zeolite membrane obtained in Example 1 is high in any of separation coefficient and permeation flux.

It is clear from Tables 2 and 3 that, in the oriented zeolite membrane obtained in Example 1, the proportion of zeolite crystals whose c-axes are oriented at an angle of 90°±33.76° relative to the surface of support is large considered from the peak data derived from individual crystal faces.

The oriented zeolite membrane obtained in Example 1 and the zeolite membrane obtained in Comparative Example 1 were subjected to X-ray diffraction (XRD) measurement using the second X-ray diffractometer under the “X-ray diffraction 2” conditions shown below.

In Tables 4 and 5 are shown the relations of the particular peak intensities obtained from the X-ray diffraction patterns of the above measurement. In Tables 6 and 7 are shown, regarding the relations of particular peak intensities, comparisons of the results of the X-ray diffraction measurement (first XRD apparatus) obtained under “X-ray diffraction 1” conditions and the results of the X-ray diffraction measurement (second XRD apparatus) obtained under “X-ray diffraction 2” conditions. In Table 4, “c-axis” indicates the total of peak intensities derived from 001 face, 002 face, 004 face, 101 face, 102 face, 103 face, 104 face, 105 face, 202 face and 303 face. “a-axis b-axis” indicates the total (total of total a and total b) of the total (total a) of peak intensities derived from 100 face, 200 face, 400 face, 301 face and 501 face and the total (total b) of peak intensities derived from 010 face, 020 face, 040 face and 051 face. “c-axis/a-axis b-axis” indicates the value obtained by dividing the “c-axis” by the “a-axis b-axis”. In Table 5, “101/020”, for example, means the value obtained by dividing the peak intensity derived from the 101 crystal face of the oriented zeolite membrane used for measurement by the peak intensity derived from the 020 crystal face of the membrane. Incidentally, in Reference Example of Table 4 and Table 5, there are shown the relations of peak intensities obtained by subjecting a single crystal powder MFI type zeolite of grain diameters 230×200×150 μm (c-axis direction length×a-axis direction length×b-axis direction length) to X-ray diffraction measurement. The MFI type zeolite powder of Reference Example was obtained by a hydrothermal synthesis.

TABLE 4

| | Peak intensity ratio |
|---|---|
| | c-axis/a-axis b-axis |
| Example 1 | 15.1 |
| Comparative Example 1 | 1.3 |
| Reference Example | 0.9 |

TABLE 5

Crystal face/
crystal face
(peak intensity
ratio)

| | 101/501 | 101/020 |
|---|---|---|
| Example 1 | 4.9 | 22.1 |
| Comparative Example 1 | 0.5 | 2.5 |
| Reference Example | 0.7 | 1.9 |

It is clear from Tables 4 and 5 that, in the oriented zeolite membrane obtained in Example 1, the proportion of zeolite crystals whose c-axes are oriented at an angle of 90°±33.76° relative to the surface of support is large considered from the peak data derived from individual crystal faces.

TABLE 6

Peak intensity ratio
c-axis/a-axis b-axis

| | First XRD | Second XRD |
|---|---|---|
| | apparatus | apparatus |
| Example 1 | 7.6 | 15.1 |
| Comparative Example 1 | 1.4 | 1.3 |

TABLE 7

| | Crystal face/crystal face | | | |
|---|---|---|---|---|
| | (peak intensity ratio) | | | |
| | First XRD | | Second XRD | |
| | apparatus | | apparatus | |
| | 101/501 | 101/020 | 101/501 | 101/020 |
| Example 1 | 3.3 | 5.7 | 4.9 | 22.1 |
| Comparative Example 1 | 0.4 | 2.0 | 0.5 | 2.5 |

It is clear from Tables 6 and 7 that, in the oriented zeolite membrane obtained in Example 1, the proportion of zeolite crystals whose c-axes are oriented at an angle of 90°±33.76° relative to the surface of support is large considered from the peak data derived from individual crystal faces when the measurement was made using Mini Flex of Rigaku Corporation (the first X-ray diffractometer) and also when the measurement was made using RINT-TTR III of Rigaku Corporation (the second X-ray diffractometer).

The peak intensity derived from each crystal face differs in some degree depending upon the kind of X-ray diffractometer used. However, a sufficient peak intensity ratio is obtained for confirmation of c-axis orientation.

### Example 2

### Preparation of Seeding Sol

33.32 g of a 40 mass % tetrapropylammonium hydroxide solution (produced by SACHEM) was mixed with 17.45 g of tetrapropylammonium bromide (produced by Wako Pure Chemical Industries, Ltd.). Thereto were added 76.17 g of distilled water and 87.5 g of an about 30 mass % silica sol [Snowtex S (trade name) produced by Nissan Chemical Industries, Ltd.]. The mixture was stirred at room temperature for 30 minutes using a magnetic stirrer to prepare a seeding sol.

### (Generation of Zeolite Seed Crystal)

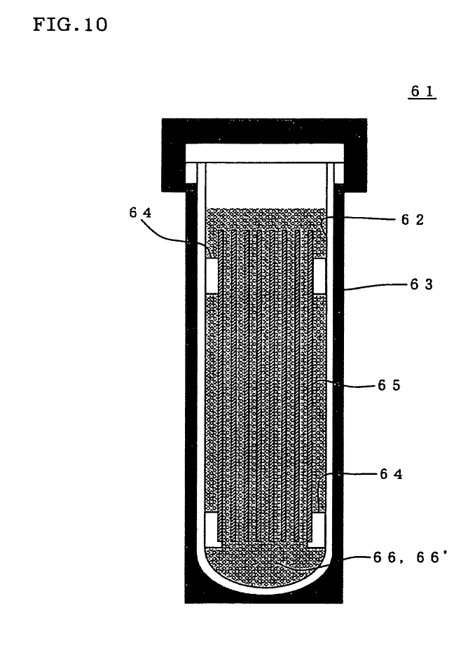

As shown in FIG. 10, the above-obtained seeding sol 66 was placed in a 300-ml stainless steel pressure-resistant vessel 61 formed by providing a fluororesin inner cylinder 62 inside a stainless steel vessel 63. Therein was immersed a monolithic porous alumina support 65 having a diameter of 30 cm, a cell (channel) inner diameter of 3 mm, 37 cells (channels) and a length of 180 mm, whose outer circumference was covered with a fluororesin tape (see FIG. 9). A reaction was allowed to take place for 10 hours in a hot-air drier of 110° C. FIG. 10 is a sectional view showing a state in which a support is fixed to a pressure-resistant vessel and a seeding sol 66 or a membrane-forming sol 66′ is placed in the vessel in Example 2. The alumina support 65 was fixed to the pressure-resistant vessel 61 using a fluororesin fixation jig 64. The support after the reaction was washed five times by boiling and then dried at 80° C. for 16 hours. The surface of the support after the reaction was observed with a scanning electron microscope (SEM). As a result, the whole surface of the porous alumina support was covered with zeolite crystal grains (zeolite seed crystal 21) of about 0.5 μm with no exposed area. It was confirmed by X-ray diffraction measurement of crystal grains that they were MFI type zeolite.

### (Preparation of Membrane-Forming Sol)

0.84 g of a 40 mass % tetrapropylammonium hydroxide solution (produced by SACHEM) was mixed with 0.44 g of tetrapropylammonium bromide (produced by Wako Pure Chemical Industries, Ltd.). Thereto were added 202.1 g of distilled water and 6.58 g of an about 30 mass % silica sol [Snowtex S (trade name) produced by Nissan Chemical Industries, Ltd.]. The mixture was stirred at room temperature for 30 minutes using a magnetic stirrer to prepare a membrane-forming sol.

### (Formation of Oriented Zeolite Membrane (Oriented Zeolite Membrane-Provided Structure))

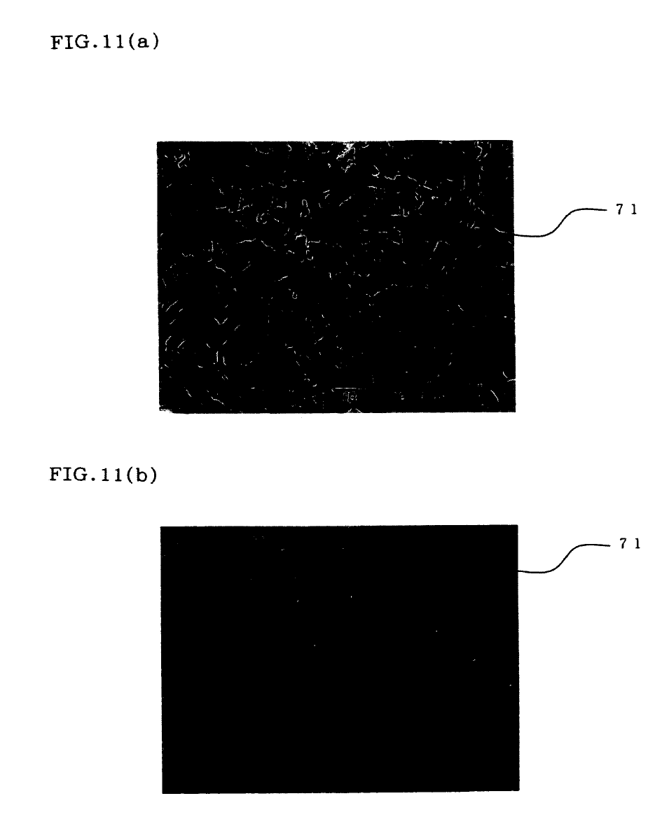

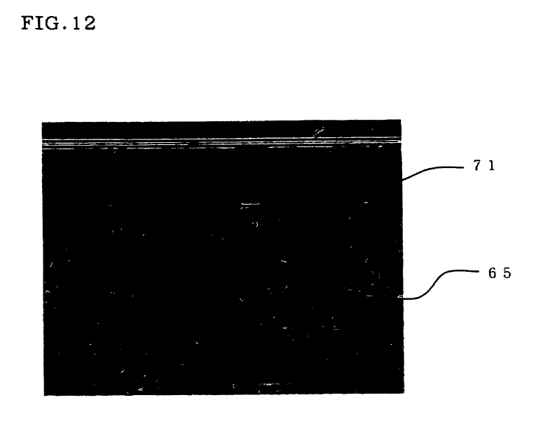

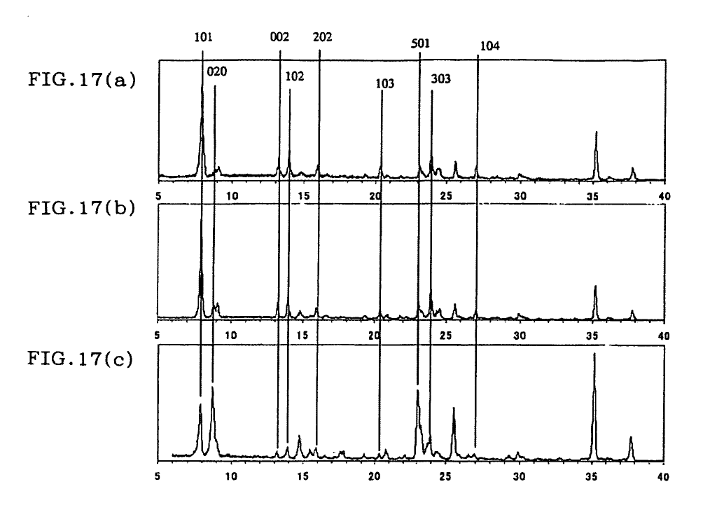

The membrane-forming sol 66′ obtained was placed in a 300-ml stainless steel pressure-resistant vessel having inside a fluororesin inner cylinder such as shown in FIG. 10 as in the above case of “generation of zeolite seed crystal”. The porous alumina support on which the zeolite seed crystal precipitated was immersed therein. A reaction was allowed to take place for 60 hours in a hot-air drier of 180° C. (reaction operation). The support after the reaction was washed five times by boiling (washing operation) and then dried at 80° C. for 16 hours (drying operation). A series of operations including the reaction operation, the washing operation and the drying operation were repeated twice in total. For the material obtained by repeating the series of operations twice, the surface and section of the surface portion of support were observed using a scanning electron microscope (SEM). As a result, as shown in the scanning electron microscope (SEM) photographs of FIG. 11(a), FIG. 11(b) and FIG. 12, formation of a dense layer (an oriented zeolite membrane 71) of about 13 μm in thickness on the inner surface of the porous alumina support 65 was confirmed. FIG. 11 is SEM photographs each showing the surface of an oriented zeolite membrane formed on the surface of the support, wherein FIG. 11(a) is a SEM photograph enlarged to 1,500 times, and FIG. 11(b) is a SEM photograph enlarged to 150 times. FIG. 12 is a sectional SEM photograph showing a state in which a zeolite membrane is formed on a support. The dense layer was subjected to X-ray diffraction (XRD) measurement under “X-ray diffraction 2” conditions described later. As a result, the dense layer was confirmed to be an MFI type zeolite crystal. Since the peak intensities derived from c-axis orientation were intense, it was also found that there was obtained a membrane whose c-axes were orientated in a direction vertical to the surface of the support. The result of X-ray diffraction measurement is shown in FIG. 17(a). In FIG. 17(a), the axis of ordinate indicates intensity (counts) and the axis of abscissa indicates 2θ (deg). The numeral given to each peak of each graph indicates a crystal face corresponding to each peak. The MFI type zeolite membrane formed on the surface of the porous alumina support was heated to 500° C. in an electric furnace and was kept therein for 4 hours to remove tetrapropylammonium to obtain an oriented zeolite membrane-provided structure having a support and an oriented zeolite membrane provided thereon.

### Example 3

### Preparation of Seeding Sol

33.32 g of a 40 mass % tetrapropylammonium hydroxide solution (produced by LION AKZO Co., Ltd.) was mixed with 17.45 g of tetrapropylammonium bromide (produced by SACHEM). Thereto were added 76.17 g of distilled water and 87.5 g of an about 30 mass % silica sol [Snowtex S (trade name) produced by Nissan Chemical Industries, Ltd.]. The mixture was stirred at room temperature for 30 minutes using a magnetic stirrer to prepare a seeding sol.

### (Generation of Zeolite Seed Crystal)

As shown in FIG. 10, the seeding sol 66 obtained was placed in a 300-ml stainless steel pressure-resistant vessel 61 formed by providing a fluororesin inner cylinder 62 inside a stainless steel vessel 63. Therein was immersed a monolithic porous alumina support 65 (see FIG. 9) of 30 mm in diameter, 3 mm in cell (channel) inner diameter, 37 cells (channels) and 180 mm in length, whose circumference was covered with a fluororesin tape. A reaction was allowed to take place for 10 hours in a hot-air drier of 110° C. The alumina support 65 was fixed inside the pressure-resistant vessel 61 using a fluororesin fixation jig 64. The support after the reaction was washed five times by boiling and then dried at 80° C. for 16 hours. The surface of the support after the reaction was observed with a scanning electron microscope (SEM). As a result, the whole surface of the porous alumina support was covered with zeolite crystal grains (a zeolite seed crystal 21) of about 0.5 μm, with no exposed area. The X-ray diffraction measurement of crystal grains confirmed that they were an MFI type zeolite.

### (Preparation of Membrane-Forming Sol)

0.84 g of a 40 mass % tetrapropylammonium hydroxide solution (produced by LION AKZO Co., Ltd.) was mixed with 0.44 g of tetrapropylammonium bromide (produced by SACHEM). Thereto were added 202.1 g of distilled water and 6.58 g of an about 30 mass % silica sol [Snowtex S (trade name) produced by Nissan Chemical Industries, Ltd.]. The mixture was stirred at room temperature for 30 minutes using a magnetic stirrer to prepare a membrane-forming sol.

### (Formation of Oriented Zeolite Membrane (Oriented Zeolite Membrane-Provided Structure))

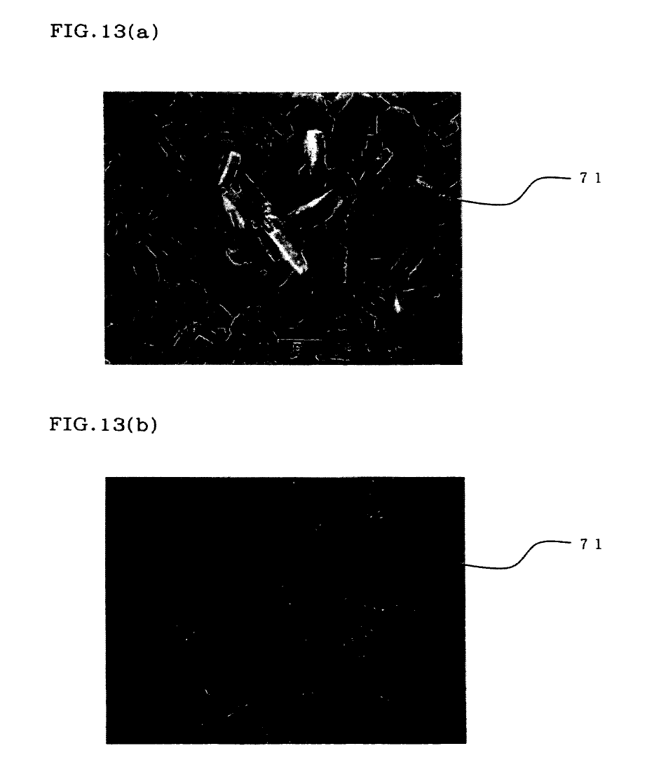

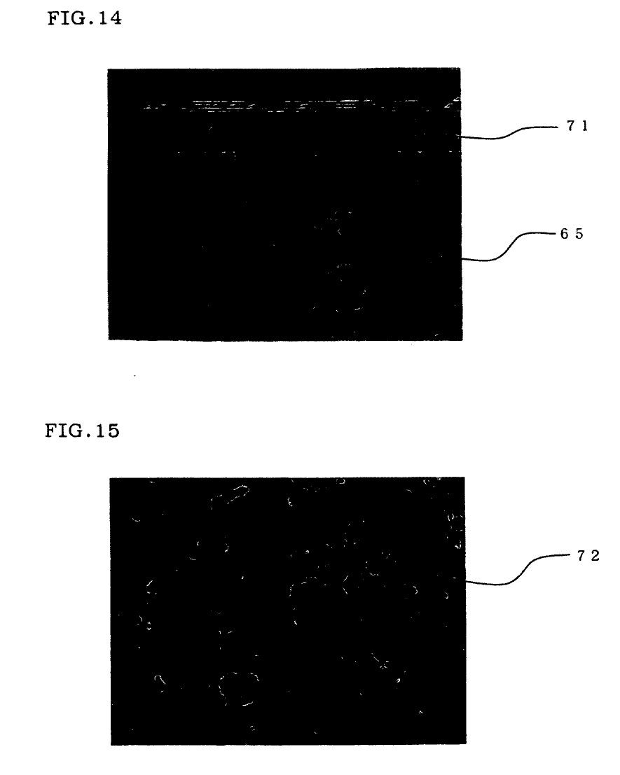

The membrane-forming sol obtained was placed in a 300-ml stainless steel pressure-resistant vessel having inside a fluororesin inner cylinder such as shown in FIG. 10 as in the above case of “generation of zeolite seed crystal”. The porous alumina support on which the zeolite seed crystal precipitated was immersed therein. A reaction was allowed to take place for 60 hours in a hot-air drier of 180° C. (reaction operation). The support after the reaction was washed five times by boiling (washing operation) and then dried at 80° C. for 16 hours (drying operation). A series of operations comprising the reaction operation, the washing operation and the drying operation was repeated twice in total. For the material obtained by repeating the series of operations twice, the surface and section of the surface portion of support were observed using a scanning electron microscope (SEM). As a result, as shown in the scanning electron microscope (SEM) photographs of FIG. 13(a), FIG. 13(b) and FIG. 14, formation of a dense layer (an oriented zeolite membrane 71) of about 13 μm in thickness on the inner surface of the porous alumina support 65 was confirmed. FIG. 13 is SEM photographs each showing the surface of an oriented zeolite membrane formed on the surface of the support, wherein FIG. 13(a) is a SEM photograph enlarged to 1,500 times, and FIG. 13(b) is a SEM photograph enlarged to 150 times. FIG. 14 is a sectional SEM photograph showing a state in which a zeolite membrane is formed on a support. The dense layer was subjected to X-ray diffraction (XRD) measurement under “X-ray diffraction 2” conditions described later. As a result, the dense layer was confirmed to be an MFI type zeolite crystal. Since the peak intensities derived from c-axis orientation were intense, it was also found out that there was obtained a membrane whose c-axes were orientated in a direction vertical to the surface of the support. The result of X-ray diffraction measurement is shown in FIG. 17(b). In FIG. 17(b), the axis of ordinate indicates intensity (counts), and the axis of abscissa indicates 2θ (deg). The MFI type zeolite membrane formed on the surface of the porous alumina support was heated to 500° C. in an electric furnace and was kept therein for 4 hours to remove tetrapropylammonium to obtain an oriented zeolite membrane-provided structure having a support and an oriented zeolite membrane provided thereon.

### Comparative Example 2

17.76 g of a 40% tetrapropylammonium hydroxide solution (produced by SACHEM) was mixed with 9.28 g of tetrapropylammonium bromide (produced by Wako Pure Chemical Industries, Ltd.). Thereto were added 97.60 g of distilled water and 70 g of an about 30 weight % silica sol [Snowtex S (trade name) produced by Nissan Chemical Industries, Ltd.]. The mixture was stirred at room temperature for 30 minutes using a magnetic stirrer to prepare a membrane-forming sol. As shown in FIG. 10, the sol was placed in a 300-ml stainless steel pressure-resistant vessel formed by providing a fluororesin inner cylinder 62 inside a stainless steel vessel 63. Therein was immersed a monolithic porous alumina support 65 (see FIG. 9) of 30 mm in diameter, 3 mm in cell (channel) inner diameter, 37 cells (channels) and 180 mm in length, whose circumference was covered with a fluororesin tape. A reaction was allowed to take place for 48 hours in a hot-air drier of 120° C. The support after the reaction was washed with hot water five times and then dried at 80° C. for 16 hours. The membrane formed had a thickness of 10 μm.

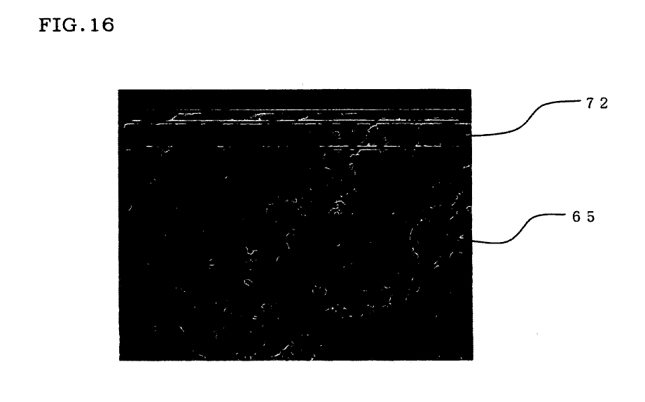

The section of the surface portion of the support of Comparative Example 2 having a zeolite membrane formed thereon was observed using a scanning electron microscope (SEM). As a result, as shown in scanning electron microscope (SEM) photographs of FIGS. 15 and 16, there had been formed, on the surface of the porous alumina support 65, zeolite membrane 72 having a non-uniform thickness and much surface unevenness. This zeolite membrane was analyzed by X-ray diffraction under the conditions of “X-ray diffraction 2” shown later, and it was confirmed that the zeolite membrane was an MFI type zeolite crystal. The result of the measurement of X-ray diffraction is shown in FIG. 17(c). In FIG. 17(c), the axis of ordinate indicates intensity (counts), and the axis of abscissa indicates 2θ (deg) Using the oriented zeolite membranes obtained in Examples 2 and 3 and the zeolite membrane obtained in Comparative Example 2, a test (a permeation test) was conducted for separation of ethanol from a mixed solution of water and ethanol by pervaporation. In the mixed solution of water and ethanol, the content of ethanol was 10% by volume. The test method by pervaporation was the same as used in the “pervaporation test” conducted for the oriented zeolite membrane-provided structure of Example 1.

### (X-Ray Diffraction 2)

Measurement is Made Using the Second X-Ray diffractometer [RINT-TTR III manufactured by Rigaku Corporation]. The test conditions are X-ray source: CuK_{α}, tube current: 50 kV, tube voltage: 300 mA, scanning axis: 2θ/θ, scanning mode: continuous, sampling width: 0.02°, scanning speed: 1°/min, diverging slit: 1.0 mm, diverging vertical slit: 10 mm, scattering slit: open, light-receiving slit: open, and opening angle of long solar slit: 0.114°.

The separation coefficients and permeation fluxes (kg/m²/hour), obtained from the above pervaporation tests are shown in Table 8. Also, the relations of the particular peak intensities obtained from the X-ray diffraction patterns are shown in Tables 9 and 10. In Table 9, “c-axis” indicates the total of peak intensities derived from 001 face, 002 face, 004 face, 101 face, 102 face, 103 face, 104 face, 105 face, 202 face and 303 face. “a-axis b-axis” indicates the total (total of total a and total b) of the total (total a) of peak intensities derived from 100 face, 200 face, 400 face, 301 face and 501 face and the total (total b) of peak intensities derived from 010 face, 020 face, 040 face and 051 face. “c-axis/a-axis b-axis” indicates the value obtained by dividing the “c-axis” by the “a-axis b-axis”. In Table 10, “101/020”, for example, means the value obtained by dividing the peak intensity derived from the 101 crystal face of the oriented zeolite membrane used for measurement by the peak intensity derived from the 020 crystal face of the membrane. Incidentally, in Reference Example of Table 9 and Table 10, there are shown the relations of peak intensities obtained by subjecting a single crystal powder MFI type zeolite of grain diameters 230×200×150 μm (c-axis direction length×a-axis direction length×b-axis direction length) to X-ray diffraction measurement. The MFI type zeolite powder of Reference Example was obtained by a hydrothermal synthesis.

TABLE 8

| | Separation | Permeation flux |
|---|---|---|
| | coefficient | (kg/m² · hour) |
| Example 2 | 50 | 2.41 |
| Example 3 | 39 | 1.92 |
| Comparative Example 2 | 34 | 1.50 |

TABLE 9

| | Peak intensity ratio |
|---|---|
| | c-axis/a-axis b-axis |
| Example 2 | 7.4 |
| Example 3 | 4.8 |
| Comparative Example 2 | 0.6 |
| Reference Example | 0.9 |

TABLE 10

Crystal face/
crystal face
(peak intensity
ratio)

| | 101/501 | 101/020 |
|---|---|---|
| Example 2 | 8.6 | 16.1 |
| Example 3 | 6.6 | 8.8 |
| Comparative Example 2 | 0.8 | 0.8 |
| Reference Example | 0.7 | 1.9 |

It is clear from Table 9, Table 10 and FIGS. 11 to 14 that the oriented zeolite membrane of Example 2 shows a higher c-axis orientation ratio than the oriented zeolite membrane of Example 3. It is clear from Table 8 that the oriented zeolite membrane of Example 2 showing a higher c-axis orientation ratio is superior in separation coefficient and permeation flux. The zeolite membrane of Comparative Example 2 is not in c-axis orientation as seen in Tables 9 and 10; therefore, the separation coefficients and permeation fluxes of the oriented zeolite membranes of Example 2 and Example 3 are superior to those of the zeolite membrane of Comparative Example 2.

### INDUSTRIAL APPLICABILITY

The present invention can be utilized as a separation membrane-provided structure which is provided with a separation membrane capable of separating a particular substance from a mixture containing a low-molecular substance, particularly as a separation membrane-provided structure capable of separating ethanol from a mixture of water and ethanol at a high efficiency.

1. An oriented zeolite membrane-provided structure comprising a support and a membrane-like, MFI type zeolite crystal (an oriented zeolite membrane) provided on the surface of the support, wherein, in the zeolite crystal, the proportion of zeolite crystals whose c-axes are oriented at an angle of 90°±33.76° relative to the surface of the support, is 90% or more of the whole zeolite crystals and the oriented zeolite membrane has a thickness of 1 to 30 μm.

2. An oriented zeolite membrane-provided structure according to claim 1, wherein, with respect to the peak intensity derived from each crystal face of the MFI type zeolite crystal, obtained by X-ray diffraction (XRD) measurement using a first X-ray diffractometer, a value obtained by dividing (a peak intensity derived from 002 face) by (a peak intensity derived from 020 face) is 2 or more, (a peak intensity derived from 002 face)/(a peak intensity derived from 101 face) is 0.5 to 1.5, (a peak intensity derived from 101 face)/(a peak intensity derived from 501 face) is 1.5 or more, and (a peak intensity derived from 303 face)/(a peak intensity derived from 501 face) is 2 or more.

3. An oriented zeolite membrane-provided structure according to claim 2, wherein, with respect to the peak intensity derived from each crystal face of the MFI type zeolite crystal, obtained by X-ray diffraction (XRD) measurement using the first X-ray diffractometer, the total of peak intensities derived from 001 face, 002 face, 004 face, 101 face, 102 face, 103 face, 104 face, 105 face, 202 face, 303 face and 404 face is at least two times the total of peak intensities derived from 010 face, 020 face, 040 face, 060 face, 100 face, 200 face, 400 face, 600 face and 501 face, and [(peak intensities derived from 10x face) (x=1 to 5)]/(a peak intensity derived from 101 face) is 3 or more.

4. An oriented zeolite membrane-provided structure according to claim 2, wherein, with respect to the peak intensity derived from each crystal face of the MFI type zeolite crystal, obtained by X-ray diffraction (XRD) measurement using a second X-ray diffractometer, the total of peak intensities derived from 001 face, 002 face, 004 face, 101 face, 102 face, 103 face, 104 face, 105 face, 202 face and 303 face is at least two times the total of peak intensities derived from 010 face, 020 face, 040 face, 051 face, 100 face, 200 face, 400 face, 301 face and 501 face.

5. An oriented zeolite membrane-provided structure according to claim 2, wherein, with respect to the peak intensity derived from each crystal face of the MFI type zeolite crystal, obtained by X-ray diffraction (XRD) measurement using the second X-ray diffractometer, the value obtained by dividing (a peak intensity derived from 101 face) by (a peak intensity derived from 501 face) is 1 or more and (a peak intensity derived from 101 face)/(a peak intensity derived from 020 face) is 3 or more.

6. An oriented zeolite membrane-provided structure according to claim 1, wherein a thickness uniformity of the oriented zeolite membrane, represented by [(maximum membrane thickness−minimum membrane thickness)/(maximum membrane thickness)]×100 is 20% or less.

7. An oriented zeolite membrane-provided structure according to claim 1, wherein the oriented zeolite membrane is a separation membrane for separating ethanol from a mixed solution of water and ethanol.

8. An oriented zeolite membrane-provided structure according to claim 2, wherein the oriented zeolite membrane is a separation membrane for separating ethanol from a mixed solution of water and ethanol.

9. An oriented zeolite membrane-provided structure according to claim 3, wherein the oriented zeolite membrane is a separation membrane for separating ethanol from a mixed solution of water and ethanol.

10. An oriented zeolite membrane-provided structure according to claim 4, wherein the oriented zeolite membrane is a separation membrane for separating ethanol from a mixed solution of water and ethanol.
